(19) United States
(12) Patent Application Publication
(10) Pub. No.: US 2009/0277068 A1
(43) Pub. Date: Nov. 12, 2009

(54) Shooting stabilizer

(76) Inventor: Jeffery Alan Lamar, Houston, TX (US)

Correspondence Address: John William Sparks, Suite 116, 1350 Nasa Parkway, Houston, TX, 77058, US

(21) Appl. No.: 12/151,316

(22) Filed: May 6, 2008

(51) Int. Cl. F41C 27/00; G03B 17/00

(52) U.S. Cl. 42/94; 396/420

(57) ABSTRACT

A shooting stabilizer is disclosed having an arm support, a clamp, an optional connection member, one or more optional and securable pivoting means, an optional support leg, and one or more optional affixing means. The shooting stabilizer provides an arm support to stabilize the shooting arm of the shooter when shooting a firearm.

### FIELD

The embodiments of this invention relate to shooting weapons and hunting, particularly hunting from blinds and stands.

### BACKGROUND

Hunters and target shooters desire accurate shots. Accurate shots are based upon a highly precise weapon, a correctly aimed targeting system, and elimination of human errors. Modern manufacturing methods for rifles produce highly precise weapons. Usually when a rifle lacks precise shots, it is the result of weapon abuse or failing to properly maintain the rifle.

A correctly aimed targeting system is the result of numerous shots, eliminating human error while shooting, and making minute adjustments of the targeting system between shots. To get a correctly aimed targeting system, the shooter should try to duplicate or utilize the applicable or expected shooting conditions when aiming their targeting system. Human errors are an inevitable element in a person aiming a targeting system.

Of the three elements of accurate shooting, human error is the most troublesome. Human error effects targeting, hunting in the field, and firing at the range. Breathing, timing the shot with the breathing, judgement of when to shoot, nervousness, body movements, distractions, and excitement are sources of human error when shooting.

A common problem of hunters is the excitement of seeing the prey. The hunter's excitement increases the heart rate, the arms and legs become unsteady, the palms sweat, and breathing becomes irregular. These symptoms are commonly called “buck fever.” The symptoms of buck fever increase the likelihood of human error.

Hunters and shooters work hard to eliminate human error. Practicing good shooting techniques is a good way to decrease human error. Another way to mitigate human error is to stabilize the human body and the weapon. Most people aim the targeting systems on their weapons by stabilizing themselves and the weapons to eliminate the human error component in aiming a targeting system.

To properly stabilize, the front of the weapon is placed on a stable surface, the upper body of the shooter is stabilized, and the back of the weapon may be stabilized. The point of stabilizing is to make minute movements of the weapon and the upper body of the shooter difficult to do. Accurate repetitive shots are the result of minimizing all movement at the time of shooting.

A good stabilization is the three-point stabilization. Three-point stabilization uses three non-aligned points to establish a maintainable position. The three non-aligned points are the same three point concept used in geometry to establish a plane. In shooting, the front of the weapon can be the first point, some portion of the upper body of the shooter can be the second point, and the back of the weapon can be the third point.

The front of the weapon and the back of the weapon are aligned points. The upper body of the shooter is usually unaligned with the other two points. This scenario is usually a three point system.

When using the shooting stabilizer in a blind or stand, the front end or forearm of the rifle is placed on a wall, window ledge, or shelf, the clamp of the shooting stabilizer is clamped to the wall, window ledge, or shelf of the blind or stand, the back end of the rifle is held against the shoulder of the shooter, and the arm attached to the shooter's shooting shoulder is placed on the arm support of the shooting stabilizer. Use of the shooting stabilizer establishes three-point stabilization. The Reinfried and Osborne inventions do not provide stabilization during shooting.

The shooting stabilizer, as claimed, is different from the Firearm Support of Reinfried, U.S. Pat. No. 4,971,208, and the Weapon Support of Osborne, U.S. Pat. No. 6,032,911. These patents are for supporting weapons (Reinfried, Abstract, first sentence and Osborne, Abstract, first sentence). The present invention stabilizes the shooting arm of the shooter by providing an “arm support” upon which the shooter can place their shooting arm. This arm support stabilizes the shooting arm by providing an additional stabilization point. Reinfried's Firearm Support does not have an “arm support.”

The clamps of Reinfried's, U.S. Pat. No. 4,971,208, Firearm Support affix the firearm in a horizontal position. The present invention clamps to a structural support, not to the weapon. Reinfried's Firearm Support has two clamps. The present invention has one clamp. Reinfried's Firearm Support is for holding the gun “to allow cleaning, repair, bore sighting, scope mounting, and the like” (Reinfried, Column 2, lines 19-23). The present invention is for shooting a weapon.

The Osborne's, U.S. Pat. No. 6,032,911, Weapon Support supports the weapon in a particular position. The present invention has an “arm support” to support the arm of the shooter when shooting. Osborne's Weapon Support does not have an “arm support.”

Osborne's, U.S. Pat. No. 6,032,911, Weapon Support is not used during the firing of the weapon. Osborne's Weapon Support holds the weapon until needed and removed (Osborne, Column 2, lines 32-35). Osborne's Weapon Support maintains the weapon in a ready position so that the hunter may retrieve the weapon and fire the weapon (Osborne, Column 2, lines 39-43). The present invention is used when shooting the weapon.

Osborne's, U.S. Pat. No. 6,032,911, Weapon Support has an extendable support that extends upwardly from the clamp. The present invention does not have an extendable support that extends upwardly from the clamp.

The Reinfried (U.S. Pat. No. 4,971,208) and Osborne (U.S. Pat. No. 6,032,911) inventions have different purposes from the purpose of the present invention. Reinfried's invention is for holding the weapon in the workshop. Osborne's invention is for holding the weapon just prior to shooting the weapon. The present invention is for stabilizing the shooting arm of the shooter when shooting the weapon. The claims of the present invention have several differences from the claims of the Reinfried and Osborne patents. The Reinfried and Osborne Patents do not mention an arm support. The present invention provides arm support for an additional point of stabilization.

A shooter utilizing the shooting stabilizer can position the shooting stabilizer to provide three-point stabilization within their blind or stand. Hunting is full of surprises. Sometimes the prey approaches the wrong side of the blind or appears in an unexpected place. The shooting stabilizer can be removed from a first position and quickly repositioned for aiming at the prey. The shooting stabilizer provides a natural or ergonomic shooting position for the shooter.

### SUMMARY

The present invention is directed to a shooting stabilizer that provides hunters and target shooters with a stable surface from which to shoot weapons. The shooting stabilizer has a clamp, an arm support, an optional connection member, one or more optional and securable pivoting means, an optional support leg, an optional barrel support arm, an optional shoulder strap, and one or more optional affixing means.

The clamp is affixed to a support structure by tightening the clamp upon the support structure. The arm support is affixed to the clamp. The connection member is disposed between the clamp and the arm support, whereby the clamp is indirectly affixed to the arm support. The connection member can be adjustable to change the length of the connection member.

The securable pivoting means is usually affixed to the end of the connection member. The securable pivoting means is a pivoting means that can be secured to a particular position. The securable pivoting means and the adjustable version of the connection member allow some embodiments to be adjustable for different hunters and different shooting conditions.

The support leg is a vertically disposed member. The support leg has a top end and a bottom end. The top end of the support leg is affixed to the back end of the shooting stabilizer. The bottom end of the support leg is placed on the floor, ground, or underlying support surface. The support leg provides additional structural support to the back end of the shooting stabilizer. The length of the support leg can be adjustable for shooters of different sizes and for different shooting conditions. The support leg can be detachable and disassembled.

An affixing means affixes the support leg to the arm support, wherein the support leg is disposed horizontally. The affixing means can revocably affix the support leg to the arm support of the shooting stabilizer. Clips, bolts, magnets, straps, and elastic loops can be the affixing means used to affix the support leg to the arm support. The support leg disposed in a horizontal position allows the shooting stabilizer to be transported in a more compact design. This is especially relevant for dense brush hunting conditions.

These and other features, aspects, and advantages of the present invention will become better understood with regard to the following description, appended claims, and accompanying drawings.

### BRIEF DESCRIPTION OF THE DRAWINGS

FIG. 1 depicts an upward and right perspective view of embodiment 100 of the shooting stabilizer,

FIG. 2 depicts a downward and left perspective view of embodiment 200 of the shooting stabilizer, and

FIG. 3 depicts an upward and right perspective view of embodiment 300 of the shooting stabilizer.

### DESCRIPTION

In accordance with some embodiments, described herein, a shooting stabilizer and a method of shooting are disclosed. The shooting stabilizer has a clamp, an arm support, an optional connection member, one or more optional and securable pivoting means, an optional support leg, an optional barrel support arm, an optional shoulder strap, and one or more optional affixing means.

The term “clamp” is any means of binding, constricting, or compressing one or more objects to hold those objects firmly. The term “clamp” expressly includes a C-clamp, a bar clamp, a quick release clamp, a pipe clamp, a handscrew clamp, or a spring clamp. The clamp can be made of metal, wood, polymer, or composite.

The term “arm support” is planar member. The term “arm support” expressly includes a horizontal support and a planar arm support. The arm support is generally disposed horizontally. The arm support can be made of wood, metal, polymer, or composite.

The term “connection member” is any member that affixes or is capable of affixing or adjoining two objects together. The term “connection member” expressly includes a member, a bar, a beam, a connecting member, an adjustable length member, or a rod.

The term “fastening means” is any fastener or fastening system. The term “fastening means” expressly includes clamps, clips, bolts and nuts, screws, welds, adhesives, pins, or vises.

The term “support leg” is a vertically or near vertically disposed member. The term “support leg” expressly includes legs, posts, monopods, and poles. The support leg can be extendable, disassembled, assembled, and retractable.

The term “barrel support arm” is a horizontally disposed member extending laterally from the front end of the shooting stabilizer. The barrel support arm is affixed is to the clamp of the shooting stabilizer.

The term “shoulder strap” is a loose strap, rope, lanyard, or belt affixed to the shooting stabilizer. The shoulder strap allows the shooting stabilizer to be carried by draping the shoulder strap over a shoulder.

The “affixing means” is any device for affixing an article. The term “affixing means” expressly includes clips, clamps, bolts, magnets, straps with a button or snap, and elastic loops.

The term “securable pivoting means” is any pivoting means that is capable of affixing or revocably affixing the angle of pivoting to a desired position. The term “securable pivoting means” expressly includes a pivoting means, a barrel swivel, a ball bearing swivel, or a hinge that has a fastening means to hinder or restrict pivoting movement. The pivoting means of the securable pivoting means can be secured by clamps, clips, pins, or cinching nuts.

A “pivoting means” is any means of pivoting. The term “pivoting means” expressly includes a barrel swivel, a ball bearing swivel, a swivel, or a hinge. A “camera” is any means of recording an image or images. The term “camera” expressly to includes a film camera, a SLR camera, a point and shoot camera, a video camera, a digital camera, or a movie camera.

The “back” and “back end” of the shooting stabilizer is the portion of the shooting stabilizer that is near the arm support of the shooting stabilizer. The “front” and “front end” of the shooting stabilizer is the portion of the shooting stabilizer that is away from the arm support. The front of the stabilizer is generally the clamp of the shooting stabilizer.

The clamp is generally disposed in a vertical and horizontal plane. The front end of the arm support is directly or indirectly affixed to the clamp. The clamp is the means for attaching the shooting stabilizer to a support structure. The applicable support structure will usually be a wall, window ledge, or shelf.

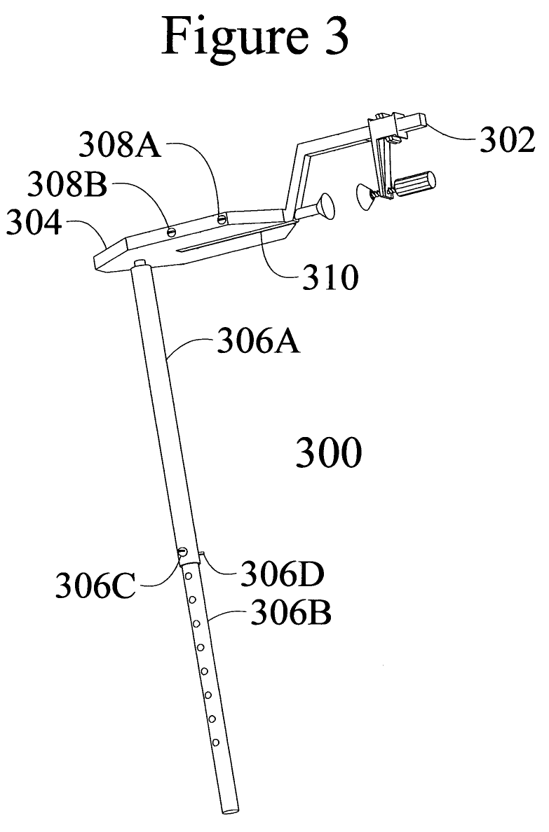

The clamp can have an angle manufactured into the stationary jaw portion of the bar clamp. This version of the bar clamp reverses the traditional positioning of the movable jaw portion of the bar clamp. This angled and reversed bar clamp is depicted in FIG. 3. With this angled and reversed bar clamp, the connecting member is disposed in a horizontal and not an angled position.

The arm support provides a stable horizontal surface at an elevation usually lower than the elevation of the front of the weapon. The lowered arm support helps provide the shooter with a more natural or ergonomic shooting position. The top surface of the arm support can be coated with a high friction surface to hinder lateral movements at the moment of shooting.

A connection member is a member that indirectly affixes the clamp to the arm support. The connection member has a first end and a second end. The first end of the connection member is affixed to the clamp. The second end of the connection member is affixed to the front end of the arm support. The connection member is usually aligned in the same vertical plane with the length of the clamp and the length of the arm support.

The connection member is usually disposed at an angle with the first end of the connection member more elevated than the second end of the connection member. The angle of the connection member lowers the elevation of the arm support relative to the clamp. This lowering of the arm support gives the shooter a more natural feeling surface from which to position the shooter's arms and from which to shoot. In some embodiments, the angle and length of the connection member is adjustable. A connecting member is a connection member.

A connecting member can have a fastening means on each end of the connecting member. A connecting member can have an adjustable length by having a worm and screw feature, a pin or pins that can be placed in a few orifices of a linear multiple orifice arrangement along adjoining members, a revocable clamp gripping a slidable member, or a latching mechanism to affix associated members at varying distances. The connecting member can have an angle in the middle of the connecting member.

The securable pivoting means is a pivoting means that can be secured at particular angles or at an angle desired by the shooter. The securable pivoting means are affixed to the ends of the connection member. The securable pivoting means are a means of indirectly affixing the clamp to the connection member and the connection member to the arm support. The securable pivoting means provide the means of adjusting the angle of the connection member to either lower or raise the arm support. The pivoting axis of the securable pivoting means affixed to either end of the connection member will generally be horizontal.

A securable pivoting means can be a pivoting means with a cinching nut to fasten the position of the pivoting. A clamp can be used to secure the securable pivoting means. A pin and multiple orifices in the pivoting means can be used to affix the position of the securable pivoting means. A clip that fits in the notches of a pivoting means can be used to affix the position of the securable pivoting means.

The pivoting axis of the securable pivoting means could be vertical. A securable pivoting means with a vertical axis would allow the arm support to be pivoted in a horizontal plane. An embodiment utilizing a securable pivoting means having a vertical pivoting axis could have two other securable pivoting means having horizontally pivoting axes, wherein the securable pivoting means with the horizontal pivoting axes are affixed to each end of the connection member and the securable pivoting means having the vertical pivoting axis could be affixed to either the securable pivoting means on the first or second end of the connection member.

The connection member and the securable pivoting means are a means of indirectly affixing the clamp to the arm support. The connection member and the securable pivoting means can both be adjustable. An embodiment with an adjustable connecting member and a securable pivoting means allow the elevation and distance of the arm support from the front of the shooting stabilizer to be adjustable.

A support leg is a support member disposed vertically or nearly vertically. The support leg has a top end and a bottom end. The support leg can be affixed to the arm support or the back end of the shooting stabilizer. The support leg is preferably affixed is to the back end of the shooting stabilizer. The support leg can be made of wood, metal, polymer, or composite.

The support leg can have an adjustable length. The support leg can be revocably affixed to the shooting stabilizer. The support leg can be pivotable by affixing a pivoting means between the support leg and the back end of the shooting stabilizer. The pivoting means of the support leg can be a securable pivoting means, a pivoting means, a hinge, or a swivel. A non-skid or high friction surface can be affixed to the bottom end of the support leg.

The support leg can have a top member and a bottom member. The top member can be a pipe with a circular clamp on the bottom end of the top member. The pipe of the top member of the support leg has a vertical orifice. The top end of the bottom member can occupy the vertical orifice of the top member. The circular clamp can be tightened or loosened on the bottom member to affix or release the bottom member from the top member. A photographic monopod can be used as a support leg.

The top member of the support leg can be bolted to the bottom member. The bottom member or the top member can have multiple horizontal orifices extending completely through the top member or the bottom member. The top member can be a pipe having a vertical orifice. The top end of the bottom member can occupy the vertical orifice of the bottom end of the top member. The height of the support leg can be adjusted by changing the horizontal orifices being occupied by the bolt affixing the top and bottom members of the support leg.

The support leg can be many different length parts which can be affixed together is in various combinations of leg parts to form a variable length support leg. This design could use male and female connectors, clamps, clips, or snap connectors.

The support leg can have a pneumatic cylinder disposed in the pipe of the top member. The pneumatic cylinder of the support leg has a pneumatic chamber, a stationary end, and a displaceable end. A hand pump with a pressure valve can be affixed to tubing. The tubing can be affixed to the pneumatic chamber of the pneumatic cylinder. The displaceable end of the pneumatic cylinder is attached to the bottom member of the support leg. The stationary end of the pneumatic cylinder is attached to the top member of the support leg. When the hand pump pressurizes the pneumatic cylinder through the tubing, the displaceable end extends away from the stationary end of the pneumatic cylinder and the bottom member of the support leg extends away from the top member of the support leg to lengthen the support leg. The valve can be opened or closed to change the length of this version of the support leg.

The barrel support arm is a support member disposed horizontally. The barrel support arm has a first end and a second end. The first end of the barrel support arm is affixed to the front end of the shooting stabilizer. The second end of the barrel support arm protrudes laterally from the front end of the shooting stabilizer. The barrel support arm can be made of wood, metal, polymer, or composite.

The front end of the weapon may be placed upon the barrel support arm. The barrel support arm provides a stable horizontal surface for the front of the weapon when there is no other appropriate horizontal support for the front of the weapon.

The barrel support arm can be detachable. The barrel support arm can be is coated with a pliable or elastic material to protect the weapon from abrasion. The barrel support arm can have a textured or high friction surface. The textured or high friction surface stabilizes the lateral movement of the weapon better than a low friction surface. Rubber, thermoelastic polymer, polymer, and fabric can be applied to the surface of the barrel support arm to protect the weapon from abrasion and to create a high friction surface.

The shoulder strap has a first end and a second end. The first end of the shoulder strap is affixed to the back of the arm support. The second end of the shoulder strap is affixed to the front of the arm support, the connection member, or to the clamp. The shoulder strap allows the shooting stabilizer to be easily carried by placing the shoulder strap over a shoulder and positioning the shooting stabilizer on the shooter's back. The shoulder strap is installed loose to allow the shoulder strap to encompass parts of the upper torso of the shooter.

The affixing means may be affixed to the bottom side of the arm support. The affixing means can affix the support leg in a horizontal position to the bottom side of the arm support. The affixing means can be affixed to the arm support with adhesives, bolts and nuts, or screws.

When the support leg is horizontally affixed to the affixing means, the shooting stabilizer is more compact and easier to transport. The support leg can be fully retracted and affixed to the arm support. The support leg can be disassembled into smaller components and affixed to the arm support. The support leg can be fully retracted and pivoted into a horizontal position for affixing to the affixing means.

A camera can be affixed to the front end of the shooting stabilizer. The camera can record the kill, prey animals, and the non-prey animals. The camera can be affixed with bolts and nuts, a clamp, or a clip that embraces the surface of the clamp of the shooting stabilizer.

The shooting stabilizer is easy to use. The shooter selects the position in the blind or stand from where to shoot. The shooter affixes the clamp of the shooting stabilizer to a wall, window ledge, or shelf of the blind or stand at a position to the left or right of his or her shooting position depending upon whether the shooter is left handed or a right handed shooter, respectively.

The humerus is the bone that extends from the shoulder to the elbow. The distance between the affixment site of the clamp and the chosen shooting position varies with the length of the humerus of the shooter and the angle of humerus that is comfortable to the shooter when shooting. Individual preferences on distance can vary. If the shooter positions the shooting stabilizer and does not like the position, the shooter can reposition the shooting stabilizer to a more comfortable position for his or her shooting arm.

If the particular design of the shooting stabilizer has an extendable connection member or securable pivoting means between the arm support and the clamp, the distances or angle can be varied to individual preferences to get a comfortable elevation and position for the arm support. A comfortable elevation of the arm support is usually about 2-8 inches below the upper side of the clamp. This elevation distance varies is with how the clamp is affixed to the supporting structure relative to the position of the front end of the weapon. An arm support at the same elevation as the upper side of the clamp is usually uncomfortable for the shooter.

The support leg can be disposed vertically between the underlying surface and the back of the shooting stabilizer. An adjustable length support leg is preferable. The height of the support leg can be adjusted to help stabilize the back end of the shooting stabilizer. If the support leg has a pivoting means, the angle of the pivoting means can be adjusted along with the length of the support leg.

The barrel support arm can be affixed to the shooting stabilizer. The barrel of weapon can be rested on the barrel support arm, the wall of the blind, shelf of the blind, or the window ledge of the blind. The shooter gets into the shooting position by placing his or her elbow on the arm support of the shooting stabilizer. If the shooter is uncomfortable or desirous of changing the positioning of the shooting stabilizer, the shooter can reposition the shooting stabilizer as the shooter desires. The shooter should position the shooting stabilizer in a position that will give the shooter good stabilization of his or her shooting stance or position.

The applicant claims a kit of parts that can be used to make a shooting stabilizer. The kit has a clamp, an arm support that can be directly or indirectly affixed to the clamp, and a connection member having a first end and a second end, wherein the first end of the connection member can be affixed to the clamp and the second end of the connection member can be affixed to the arm support, whereby the clamp can be indirectly affixed to the arm support by the connection member.

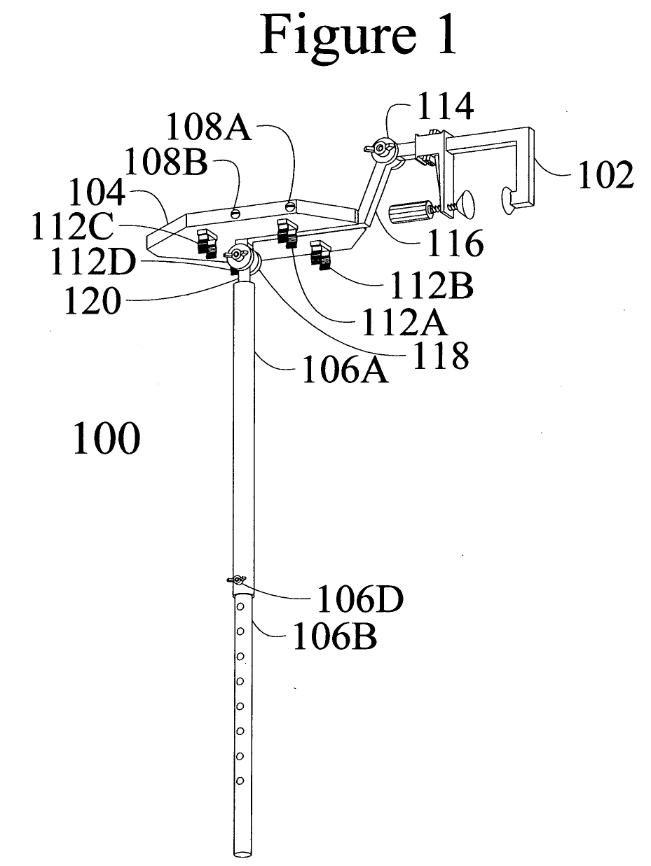

In FIG. 1, embodiment 100 of the shooting stabilizer is depicted. Embodiment 100 has a bar clamp 102, a first securable pivoting means 114, a connecting member 116, an arm support 104, arm support bolts (a front arm support bolt 108A and a back arm support bolt 108B, collectively 108), nuts (a front nut 110A (not visible and not labeled) and a back nut 110B (not visible and not labeled), collectively 110), a second securable pivoting means 118, an extendable support leg (a top member 106A, a bottom member 106B, a leg bolt 106C (not visible and not labeled), and a wing nut 106D, collectively 106), an attachment member 120, and clips (a front right clip 112A, a front left clip 112B, a back right clip 112C, and a back left clip 112D (partially visible), collectively 112, singularly clip).

The bar clamp 102 is a quick release bar clamp. The bar clamp 102 is disposed in a vertical plane. The bar clamp 102 is affixed to the first securable pivoting means 114.

The connecting member 116 is a member having a top side, a bottom side, a front end, a middle region, and a back end. The connecting member 116 has an angle near the middle of the member. The connecting member 116 is disposed in a vertical plane. The back end of the connecting member 116 is disposed horizontally. The front end of the connecting member 116 is disposed at an angle in a vertical plane. The connecting member 116 has two horizontal orifices (not visible) extending transversely through the connecting member 116. The two horizontal orifices of the connecting member 116 are separately positioned near the middle region of the connecting member and behind the angle of the connecting member. The connecting member 116 is pivotably affixed to the first securable pivoting means 114. The connecting member 116 pivots on the horizontal and transverse axis of the second securable pivoting means 118.

The arm support 104 is a planar member disposed horizontally. The arm support 104 has a top side, a bottom side, a left side, a right side, a front end, a middle region, and a back end, wherein the middle region is between the front end and the back end of the arm support 104. The arm support 104 has a horizontal slot extending completely through the arm support 104 from the top side to the bottom side of the arm support and the horizontal slot extends partially through the arm support from the front end to near the middle region of the arm support 104. The back end of the connecting member 116 occupies the horizontal slot of the arm support 104. The arm support 104 has two horizontal orifices extending transversely through the arm support 104. The two horizontal orifices of the arm support 104 are aligned with the orifices of the connecting member 116.

The arm support bolts 108 are disposed horizontally and transversely. The arm support bolts 108 occupy the orifices of the arm support 104 and the orifices of the connecting member 116. The arm support bolts 108 protrude from both sides of the arm support 104. The arm support 104 is affixed to the connecting member 116 with arm support bolts 108 and nuts 110 (not visible) on the end of the bolts 108.

The second securable pivoting means 118 is affixed to the bottom side of the back end of the connecting member 116. The attachment member 120 is a cylindrical member disposed vertically. The attachment member 120 is affixed to the second securable pivoting means 118. The attachment member 120 has a centrally located vertical orifice extending partially through the attachment member 120 from the bottom side to near the top side of the attachment member 120. The vertical orifice of the attachment member 120 is threaded. The attachment member 120 pivots on the horizontal and transverse axis of the second securable pivoting means 118.

The extendable support leg 106 is a variable length member that is disposed vertically. The top member 106A is a vertically disposed pipe having a top end and a bottom end. The top member 106A, being a pipe, has a vertical orifice. The top member 106A has a threaded bolt (not visible) affixed to the top end of the top member 106A. The threaded bolt of the top end of the top member 106A is disposed vertically. The top member 106A has a transverse orifice extending through the top member 106A near the bottom end of the top member 106A.

The threaded bolt of the top end of the top member 106A occupies the vertical orifice of the attachment member 120. The extendable support leg 106 is revocably affixed to the attachment member 120 by the threaded bolt of the top end of the top member 106A. The extendable support leg 106 pivots on the horizontal and transverse axis of the second securable pivoting means 118.

The bottom member 106B is a vertically disposed member having a top end, a middle region, and a bottom end. The bottom member 106B has multiple transverse orifices extending through the bottom member 106B near the top end of the bottom member 106B and near the middle region of the bottom member 106B. The multiple transverse orifices of the bottom member 106B are aligned along the center of the length of the bottom member 106B. The top end of the bottom member 106B occupies the vertical orifice of the top member 106A.

The leg bolt 106C (not visible) is a threaded bolt disposed transversely. The leg bolt 106C occupies the transverse orifice of the top member 106A. The leg bolt 106C occupies one transverse orifice of the bottom member 106B. The wing nut 106D is revocably affixed to the threaded end of the leg bolt 106C. The length of the extendable support leg 106 is changed by changing the transverse orifice of the bottom member 106B being occupied by the leg bolt 106C. The bottom member 106B can have a high friction surface affixed to the bottom end of the bottom member 106B.

The clips 112 have a base end and two projecting ends. The base ends of the clips 112 are affixed to the bottom side of the arm support 104. The projecting ends of the clips 112 extend downward from the base end of the clips 112 and the arm support 104. The projecting ends of the clips 112 have a top end, a middle region, and a bottom end. The middle region of the clips 112 have curved portions that form concave surfaces. The concave surfaces of the opposing projecting ends of each clip face each other. The concave surfaces of each clip form a near circular region for embracing circular objects of certain size ranges. The concave surfaces of each clip may revocably affix the extendable support leg 106 or portions of the extendable support leg 106 in a horizontal position once the extendable support leg 106 is removed from the vertical orifice of the attachment member 120. The clips 112 allow the extendable support leg 106 to be stored in a horizontal position for more compactness. The clips 112 may be affixed to the arm support 104 by adhesives, screws, or bolts and nuts.

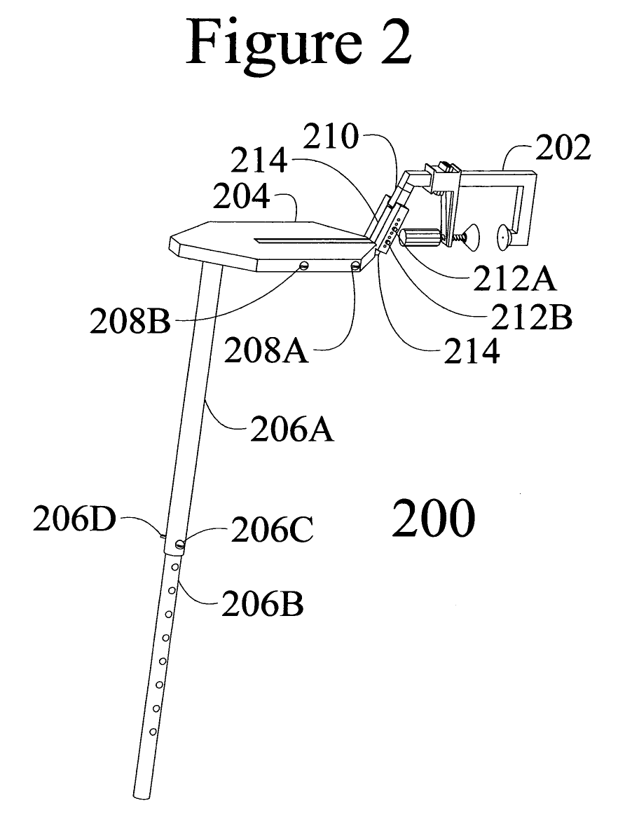

In FIG. 2, embodiment 200 of the shooting stabilizer is depicted. Embodiment 200 has a vertical bar clamp 202, an adjustable member 210, a connecting member 214, retaining pins (a front retaining pin 212A and a back retaining pin 212B, collectively 212), a horizontal support 204, horizontal support bolts (a front horizontal support bolt 208A and a back horizontal support bolt 208B, collectively 208), nuts (a front nut 216A (not visible and not labeled) and a back nut 216B (not visible and not labeled), collectively 216), and a variable support leg (a top member 206A, a bottom member 206B, a leg bolt 206C, and a wing nut 206D, collectively 206).

The vertical bar clamp 202 is a quick release bar clamp. The vertical bar clamp 202 is disposed in a vertical plane. The adjustable member 210 has a base end and two projecting ends. The adjustable member 210 is disposed at an angle in a vertical plane that aligns with the length of the vertical bar clamp 202. The projecting ends of the adjustable member 210 are parallel to each other. The projecting ends of the adjustable member 210 extend from the base end of the adjustable member in the same direction. The projecting ends of the adjustable member 210 have multiple transverse orifices extending through the projecting ends of the adjustable member 210. The multiple transverse orifices of the adjustable member 210 are aligned along the center of the length of the projecting ends of the adjustable member 210.

The retaining pins 212 are horizontally disposed pins. The retaining pins 212 are capable of occupying the transverse orifices of the adjustable member 210. The retaining pins 212 tightly fit the transverse orifices of the adjustable member 210.

The connecting member 214 is a member having a top side, a bottom side, a front end, a middle region, and a back end. The connecting member 214 has an angle near the middle of the member. The connecting member 214 is disposed in a vertical plane that aligns with the length of the vertical bar clamp 202. The back end of the connecting member 214 is disposed horizontally. The front end of the connecting member 214 is disposed at an angle in a vertical plane. The front end of the connecting member 214 has two transverse orifices extending through the front end of the connecting member 214. The transverse orifices of the connecting member 214 are aligned along the center of the length of the front end of the connecting member 214. The transverse orifices of the front end of the connecting member 214 are aligned with the transverse orifices of the adjustable member 210.

The front end of the connecting member 214 occupies the space between the projecting ends of the adjustable member 210. The retaining pins 212 occupy the transverse orifices of the front end of the connecting member 214 and the transverse orifices of the adjustable member 210 to revocably affix the connecting member 214 to the adjustable member 210.

The connecting member 214 has two horizontal orifices (not visible) extending transversely through the connecting member 214 near the middle region of the connecting member 214 and behind the angle of the connecting member 214. The horizontal orifices of the connecting member 214 are aligned on the same horizontal plane and separated from each other.

The horizontal support 204 is a planar member disposed horizontally. The horizontal support 204 has a top side, a bottom side, a left side, a right side, a front end, a middle region, and a back end, wherein the middle region is between the front end and the back end of the horizontal support 204. The horizontal support 204 has a vertical threaded hole in the bottom side of the horizontal support 204 near the back end of the horizontal support 204. The vertical threaded hole of the horizontal support 204 extends partially into the horizontal support 204. The horizontal support 204 has a horizontal slot extending completely through the horizontal support 204 from the top side to the bottom side of the horizontal support and the horizontal slot extends partially through the horizontal support from the front end to near the middle region of the horizontal support 204.

The back end of the connecting member 214 occupies the horizontal slot of the horizontal support 204. The horizontal support 204 has two horizontal orifices extending transversely through the horizontal support 204. The two horizontal orifices of the horizontal support 204 are aligned with the horizontal orifices of the connecting member 214.

The horizontal support bolts 208 are disposed horizontally and transversely. The horizontal support bolts 208 occupy the horizontal orifices of the horizontal support 204 and the horizontal orifices of the connecting member 214. The horizontal support bolts 208 protrude from both sides of the horizontal support 204. The horizontal support 204 is affixed to the connecting member 214 with horizontal support bolts 208 and nuts 216 (not visible) on the end of the horizontal support bolts 208.

The variable support leg 206 is a variable length member that is disposed vertically. The top member 206A is a vertically disposed pipe having a top end and a bottom end. The top member 206A, being a pipe, has a vertical orifice. The top member 206A has a threaded bolt (not visible) affixed to the top end of the top member 206A. The threaded bolt of the top end of the top member 206A is disposed vertically. The top member 206A has a transverse orifice extending through the top member 206A near the bottom end of the top member 206A.

The threaded bolt of the top end of the top member 206A occupies the threaded vertical orifice of the horizontal support 204. The variable support leg 206 is revocably affixed to the horizontal support 204 by the threaded bolt of the top end of the top member 206A.

The bottom member 206B is a vertically disposed member having a top end, a middle region, and a bottom end. The bottom member 206B has multiple transverse orifices extending through the bottom member 206B near the top end of the bottom member 206B and near the middle region of the bottom member 206B. The multiple transverse orifices of the bottom member 206B are aligned along the center of the length of the bottom member 206B. The top end of the bottom member 206B occupies the vertical orifice of the top member 206A.

The leg bolt 206C (not visible) is a threaded bolt disposed transversely. The leg bolt 206C occupies the transverse orifice of the top member 206A. The leg bolt 206C occupies one transverse orifice of the bottom member 206B. The wing nut 206D is revocably affixed to the threaded end of the leg bolt 206C. The length of the variable support leg 206 is changed by changing the transverse orifice of the bottom member 206B being occupied by the leg bolt 206C. The bottom member 206B can have a high friction surface affixed to the bottom end of the bottom member 206B.

In FIG. 3, embodiment 300 of the shooting stabilizer is depicted. Embodiment 300 has a projecting clamp 302, a horizontal member 310, a planar arm support 304, bolts (a front bolt 308A and a back bolt 308B, collectively 308), nuts (a front nut 312A (not visible) and a back nut 312B (not visible), collectively 312), and an adjustable support leg 306 (a top member 306A, a bottom member 306B, a leg bolt 306C, and a wing nut 306D, collectively 306).

The projecting clamp 302 is a different version of a quick release bar clamp. The projecting clamp 302 has a stationary jaw that is set at an angle and the projecting clamp is disposed in a reverse direction on a vertical axis when compared to the embodiments 100 and 200. The stationary jaw of the projecting clamp 302 has a top end and a bottom end. The projecting clamp 302 is disposed in a vertical plane.

The horizontal member 310 is a member having a top side, a bottom side, a front end, a middle region, and a back end. The horizontal member 310 is disposed horizontally. The front end of the horizontal member 310 is affixed near the bottom end of the stationary jaw of the projecting clamp 302.

The horizontal member 310 has two horizontal orifices (not visible) extending transversely through the horizontal member 310. The two horizontal orifices of the horizontal member 310 are separately positioned near the middle region of the horizontal member 310. The two horizontal orifices of the horizontal member 310 are aligned on a horizontal plane.

The planar arm support 304 is a planar member disposed horizontally. The planar arm support 304 has a top side, a bottom side, a left side, a right side, a front end, a middle region, and a back end, wherein the middle region is between the front end and the back end of the planar arm support 304. The planar arm support 304 has a horizontal slot extending completely through the planar arm support 304 from the top side to the bottom side of the planar arm support and the horizontal slot extends partially through the planar arm support from the front end to near the middle region of the planar arm support 304. The planar arm support 304 has a vertical orifice extending partially through the planar arm support 304 from the bottom side to near the top side of the planar arm support 304. The vertical orifice of the planar arm support 304 is threaded.

The back end of the horizontal member 310 occupies the horizontal slot of the planar arm support 304. The planar arm support 304 has two horizontal orifices extending transversely through the planar arm support 304. The two horizontal orifices of the planar arm support are aligned with the horizontal orifices of the horizontal member 310.

The bolts 308 are disposed horizontally and transversely. The bolts 308 occupy the horizontal orifices of the planar arm support 304 and the horizontal orifices of the horizontal member 310. The bolts 308 protrude from both sides of the planar arm support 304. The planar arm support 304 is affixed to the horizontal member 310 with is bolts 308 and nuts 310 (not visible) on the end of the bolts 308.

The adjustable support leg 306 is a variable length member that is disposed vertically. The top member 306A is a vertically disposed pipe having a top end and a bottom end. The top member 306A, being a pipe, has a vertical orifice. The top member 306A has a threaded bolt (not visible) affixed to the top end of the top member 306A. The threaded bolt of the top end of the top member 306A is disposed vertically. The top member 306A has a transverse orifice extending through the top member 306A near the bottom end of the top member 306A.

The threaded bolt of the top end of the top member 306A occupies the vertical orifice of the planar arm support 304. The adjustable support leg 306 is revocably affixed to the planar arm support 304 by the threaded bolt of the top end of the top member 306A being rotated into the threaded vertical orifice of the planar arm support 304.

The bottom member 306B is a vertically disposed member having a top end, a middle region, and a bottom end. The bottom member 306B has multiple transverse orifices extending through the bottom member 306B near the top end of the bottom member 306B and near the middle region of the bottom member 306B. The multiple transverse orifices of the bottom member 306B are aligned vertically along the bottom member 306B. The top end of the bottom member 306B occupies the vertical orifice of the top member 306A.

The leg bolt 306C (not visible) is a threaded bolt disposed transversely. The leg bolt 306C occupies the transverse orifice of the top member 306A. The leg bolt 306C occupies one transverse orifice of the bottom member 306B. The wing nut 306D is revocably affixed to the threaded end of the leg bolt 306C. The length of the adjustable support leg 306 is changed by changing the transverse orifice of the bottom member 306B being occupied by the leg bolt 306C.

The preferred embodiments have an adjustable support leg, one or more clips, two or more securable pivoting means, and an adjustable length connecting member. The arm support is preferably about 14 inches long, 4-8 inches wide, and one inch thick. The clamp is preferably a quick release bar clamp.

While the invention has been described with respect to a limited number of embodiments, those skilled in the art will appreciate numerous modifications and variations therefrom. It is intended that the appended claims cover all such modifications and variations as fall within the true spirit and scope of the invention.

What is claimed is:

1. A shooting stabilizer, the article comprising:
a clamp, and
an arm support affixed to the clamp.

2. The shooting stabilizer of claim 1, wherein the arm support is horizontally disposed.

3. The shooting stabilizer of claim 1, further comprising:
a connection member having a first end and a second end, wherein the first end of the connection member is affixed to the clamp and the second end of the connection member is affixed to the arm support, whereby the connection member is disposed between the clamp and the arm support and the connection member affixes the clamp to the arm support.

4. The shooting stabilizer of claim 3, wherein the connection member is disposed at an angle in a vertical plane.

5. The shooting stabilizer of claim 1, further comprising:
a camera, wherein the camera is affixed to the shooting stabilizer.

6. The shooting stabilizer of claim 3, further comprising:
one or more securable pivoting means, wherein the securable pivoting means are disposed at the ends of the connection member and the securable pivoting means pivotably affix the connection member to the adjoining components.

7. The shooting stabilizer of claim 1, wherein the clamp is a quick release bar clamp.

8. The shooting stabilizer of claim 6, wherein one or more securable pivoting means pivot on a horizontal axis.

9. The shooting stabilizer of claim 6, wherein one or more securable pivoting means pivot on a vertical axis.

10. The shooting stabilizer of claim 3, wherein the connection member is extendable.

11. The shooting stabilizer of claim 1, wherein the arm support is elongated.

12. The shooting stabilizer of claim 1, further comprising:
a support leg, wherein the support leg is affixed to the back end of the shooting stabilizer.

13. The shooting stabilizer of claim 1, further comprising:
a support leg, wherein the support leg is revocably affixed to the back end of the shooting stabilizer.

14. The shooting stabilizer of claim 13, wherein the support leg is extendable.

15. The shooting stabilizer of claim 13, further comprising:
a pivoting means, wherein the pivoting means is disposed between the support leg and the arm support.

16. The shooting stabilizer of claim 13, further comprising:
one or more affixing means, wherein the affixing means affix the support leg to the arm support, wherein the support leg is parallel with the arm support.

17. The shooting stabilizer of claim 1, further comprising:
a barrel support arm having a first end and a second end, wherein the first end of the barrel support arm is affixed to the front end of the shooting stabilizer and the barrel support arm protrudes laterally from the front end of the shooting stabilizer.

18. The shooting stabilizer of claim 1, wherein the clamp is horizontally disposed.

19. A kit to make a shooting stabilizer, the kit comprising:
a clamp, and
an arm support that can be attached to the clamp.

20. The kit of claim 19, further comprising:
a connection member having a first end and a second end, wherein the first end of the connection member can be affixed to the clamp and the second end of the connection member can be affixed to the arm support, whereby the clamp is indirectly affixed to the arm support by the connection member.
